(19) United States
(12) Patent Application Publication
(10) Pub. No.: US 2025/0104283 A1
(43) Pub. Date: Mar. 27, 2025

(54) Image Processing Method, Image Processing Apparatuses and Readable Storage Medium

(71) Applicant: BOE Technology Group Co., Ltd., Beijing (CN)

(72) Inventors: Ran Duan, Beijing (CN); Yanhong Wu, Beijing (CN)

(73) Assignee: BOE Technology Group Co., Ltd., Beijing (CN)

(21) Appl. No.: 18/730,956

(22) PCT Filed: Mar. 24, 2023
(86) PCT No.: PCT/CN2023/083599

§ 371 Date: Jul. 22, 2024

(30) Foreign Application Priority Data
Apr. 28, 2022 (CN) 202210469352.6

(51) Int. Cl. G06T 7/90; G06T 5/20; G06T 5/50; G06T 7/11; G06T 7/194; G06T 11/00; G06T 11/60; G06V 30/14

(52) U.S. Cl. CPC G06T 7/90; G06T 5/20; G06T 5/50; G06T 7/11; G06T 7/194; G06T 11/001; G06T 11/60; G06V 30/1444; G06T 2207/10024; G06T 2207/20221; G06T 2207/30201

(57) ABSTRACT

An image processing method, an image processing device, and a readable storage medium are provided. The image processing method includes: acquiring an input image; acquiring at least two intermediate images based on the input image; acquiring an output image based on the at least two intermediate images. Each of the at least two intermediate image corresponds to a single type of image content, different intermediate images correspond to different types of image content, and different intermediate images correspond to different color filtering processes.

The present disclosure claims the priority of China Patent Application No. 202210469352.6, filed on Apr. 28, 2022, the entirety of which is referenced hereby as a part of the present disclosure.

### TECHNICAL FIELD

The embodiments of the present disclosure relate to an image processing method, an image processing device, and a non-transitory readable storage medium.

### BACKGROUND

The current image processing technology includes color filtering processing technology. Generally, the color filtering processing is to convert a color image in RGB color space into an image containing only a limited number of colors by a certain mapping rule. The general image three-color filtering algorithm converts a color image into an image with three colors, red, black, and white, and makes use of the sparsity of colors to present changes in image colors such as change in brightness, shade and the like, thereby preserving the visual information for the original color image. The better the performance of the color filtering algorithm is, the closer the processing result is to the original color image.

### SUMMARY

At least one embodiment of the present disclosure provides an image processing method, which includes: acquiring an input image; acquiring at least two intermediate images based on the input image; acquiring an output image based on the at least two intermediate images. Each of the at least two intermediate image corresponds to a single type of image content, different intermediate images correspond to different types of image content, and different intermediate images correspond to different color filtering processes.

For example, in the image processing method provided by at least one embodiment of that present disclosure, acquiring the at least two intermediate images based on the input image includes: acquiring at least two preliminary images base on that input image, and acquiring the at least two intermediate images based on the at least two preliminary images. Each of the at least two preliminary images corresponds to a single type of image content, and the at least two preliminary images correspond to the at least two intermediate images one by one.

For example, in the image processing method provided by at least one embodiment of that present disclosure, the at least two preliminary images include at least two of the first preliminary image, the second preliminary image, the third preliminary image, and the fourth preliminary image. The first preliminary image corresponds to a text type of image content, the second preliminary image corresponds to a portrait type of image content, the third preliminary image corresponds to a geometric graphic type of image content, and the fourth preliminary image corresponds to a background type of image content.

For example, in the image processing method provided by at least one embodiment of that present disclosure, acquiring the at least two preliminary images based on the input image includes: performing text detection on the input image to acquire the first preliminary image; performing portrait detection on the input image to acquire the second preliminary image; and/or performing geometric graphic detection on the input image to acquire the third preliminary image.

For example, in the image processing method provided by at least one embodiment of that present disclosure, acquiring the at least two preliminary images based on the input image includes: acquiring the fourth preliminary image based on the first preliminary image, the second preliminary image, and the third preliminary image.

For example, in the image processing method provided by at least one embodiment of that present disclosure, acquiring the at least two intermediate images based on the at least two preliminary images includes: acquiring the first intermediate image based on the first preliminary image and the input image applied by text color filtering processing; acquiring the second intermediate image based on the second preliminary image and the input image applied by portrait color filtering processing; acquiring the third intermediate image based on the third preliminary image and the input image applied by geometric graphic color filtering processing; and/or acquiring the fourth intermediate image based on the fourth preliminary image and the input image applied by background color filtering processing.

For example, in the image processing method provided by at least one embodiment of that present disclosure, acquiring the output image based on the at least two intermediate images includes: merging the first intermediate image, the second intermediate image, the third intermediate image, and the fourth intermediate image to obtain the output image.

For example, in the image processing method provided by at least one embodiment of that present disclosure, merging the first intermediate image, the second intermediate image, the third intermediate image, and the fourth intermediate image to obtain the output image includes: adding, in response to no overlapping part existing among the first intermediate image, the second intermediate image, the third intermediate image, and the fourth intermediate image, respective pixel values in the first intermediate image, the second intermediate image, the third intermediate image, and the fourth intermediate image to obtain the output image.

For example, in the image processing method provided by at least one embodiment of that present disclosure, merging the first intermediate image, the second intermediate image, the third intermediate image, and the fourth intermediate image to obtain the output image includes: determining, in response to an overlapping part existing among the first intermediate image, the second intermediate image, the third intermediate image, and the fourth intermediate image, pixel values of the overlapping part based on an intermediate image with the highest priority of at least two intermediate images including the overlapping part.

For example, in the image processing method provided by at least one embodiment of that present disclosure, a priority order of the first intermediate image, the second intermediate image, the third intermediate image, and the fourth intermediate image is the first intermediate image>the second intermediate image>the third intermediate image>the fourth intermediate image.

For example, in the image processing method provided by at least one embodiment of that present disclosure, acquiring at least two preliminary images based on the input image includes: taking, in response to the input image being an editable vector graph having at least two layers, the at least two layers respectively as the at least two preliminary images. Each of the at least two layers corresponds to a single type of image content.

For example, in the image processing method provided by at least one embodiment of that present disclosure, acquiring the at least two intermediate images based on the at least two preliminary images includes: performing a corresponding color filtering process on each of the at least two preliminary images to obtain the at least two intermediate images.

For example, in the image processing method provided by at least one embodiment of that present disclosure, each of the at least two preliminary images is a binary image.

For example, in the image processing method provided by at least one embodiment of that present disclosure, the different color filtering processes include at least using different color filtering parameters.

At least one embodiment of the present disclosure also provides an image processing device, which includes: an input module, an acquisition module, and a processing module. The input module is configured to acquire an input image. The acquisition module is configured to acquire at least two intermediate images based on the input image. The processing module is configured to acquire an output image based on the at least two intermediate images. Each of the at least two intermediate image corresponds to a single type of image content, different intermediate images correspond to different types of image content, and different intermediate images correspond to different color filtering processes.

At least one embodiment of the present disclosure also provides an image processing device, which includes: a processor and a memory. The memory includes one or more computer program modules. The one or more computer program modules are stored in the memory and configured to be executed by the processor, and the one or more computer program modules include instructions for performing the image processing method according to any of embodiments in the present disclosure.

A non-transitory readable storage medium having computer instructions stored thereon, the computer instructions, when executed by a processor, perform the image processing method according to any of embodiments in the present disclosure.

### BRIEF DESCRIPTION OF DRAWINGS

In order to illustrate the technical schemes of the embodiments of the present disclosure more clearly, the following drawings will be briefly introduced. Obviously, the drawings described below merely relate to some of the embodiments of the present disclosure, and are not limitations to the present disclosure.

FIG. 1 is a schematic flowchart of an image processing method provided by at least one embodiment of the present disclosure;

FIG. 2 is an operational flowchart of an image processing method provided by at least one embodiment of the present disclosure;

FIG. 3 is a schematic diagram of an image processing method provided by at least one embodiment of the present disclosure;

FIG. 4 is a schematic diagram of a geometric graphic detection algorithm provided by at least one embodiment of the present disclosure;

FIG. 5 is a schematic diagram of a text detection algorithm provided by at least one embodiment of the present disclosure;

FIG. 6 is a schematic diagram of a portrait detection algorithm provided by at least one embodiment of the present disclosure;

FIG. 7 is a schematic diagram of a text color filtering algorithm provided by at least one embodiment of the present disclosure;

FIG. 8 is a schematic diagram of a portrait color filtering algorithm provided by at least one embodiment of the present disclosure;

FIG. 9 is a schematic diagram of a geometric graphic color filtering algorithm provided by at least one embodiment of the present disclosure;

FIG. 10 is a schematic diagram of a natural image color filtering algorithm provided by at least one embodiment of the present disclosure;

FIG. 11 is a schematic block diagram of an image processing method provided by at least one embodiment of the present disclosure;

FIG. 12 is a schematic block diagram of another image processing method provided by at least one embodiment of the present disclosure;

FIG. 13 is a schematic block diagram of an image processing device provided by at least one embodiment of the present disclosure;

FIG. 14 is a schematic block diagram of another image processing device provided by at least one embodiment of the present disclosure;

FIG. 15 is a schematic block diagram of yet another image processing device provided by at least one embodiment of the present disclosure;

FIG. 16 is a schematic block diagram of a non-transitory readable storage medium provided by at least one embodiment of the present disclosure; and

FIG. 17 is a schematic block diagram of an electronic device provided by at least one embodiment of the present disclosure.

### DETAILED DESCRIPTION

In order to make objects, technical schemes and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Flowcharts are used in the present disclosure to illustrate operations performed by a system according to at least one embodiment of the present disclosure. It should be understood that the preceding or following operations are not necessarily performed accurately in order. On the contrary, various steps can be processed in a reverse order or parallelly according to requirements. Also, other operations can be added to these processes, or one or more steps can be removed from these processes.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

An existing image color conversion algorithm applied to ink screen is typically to present changes in color, texture, gray scale, etc., for a color image by means of available similar colors and sparsity of pixel points based on a certain color mapping rule and an error diffusion algorithm, but for a real application scenario, it is difficult for a single conversion algorithm to accommodate such complex application scenario. For one example, the contents of the products such as table cards used for a conference scenario are mainly simple graphic elements containing elements such as texts, tables, and etc. In such a scenario, the binary images with clear outlines and obvious boundaries are more in line with the requirements of users. For another example, with respect to the products such as bus handles, smart chest cards and etc., the contents thereof needed to be presented are advertisements dominated by color images as well as complex contents containing personal ID photos. In such a scenario, the color filtering algorithm is required to be able to present gradient textures of images and personal facial details as much as possible through the diffusion algorithm. Meanwhile, the contents of the advertisements and chest cards may further contain related text introductions, which also needs the presentation effect for the former scenario. In the case that both types of contents with contradictory requirements appear in the same scenario, the requirements cannot be met by using just the single algorithm. Therefore, it is required to design an application scheme for color filtering algorithm to accommodate more complex scenarios.

Generally, while the conventional color filtering algorithms for processing natural images have good effects, when used to process other types of image content (e.g., graphics, texts, portraits), it is easy to lead to problems esthetically affecting the appearance, such as jagging, particles, and etc.

In order to overcome at least the above technical problems, at least one embodiment of the present disclosure provides an image processing method, which includes acquiring an input image; acquiring at least two intermediate images based on the input image; acquiring an output image based on the at least two intermediate images. Each of the at least two intermediate image corresponds to a single type of image content, different intermediate images correspond to different types of image content, and different intermediate images correspond to different color filtering processes.

Correspondingly, at least one embodiment of the present disclosure also provides an image processing device and non-transitory readable storage medium corresponding to the image processing method described above.

Through the image processing method provided by at least one embodiment of the present disclosure, an input image can be classified, for example, into at least two intermediate images of different types, and a corresponding color filtering process can be used adaptively, so as to meet different requirements for different types of image contents in the same image, solving the problem of bad color filtering effect due to use of single color filtering algorithm in complex scenario.

The image processing method provided according to at least one embodiment of the present disclosure will be illustrated in a non-limiting manner through several examples or embodiments. As described below, without mutually conflicting, different features in these specific examples or embodiments can be combined with each other, so as to obtain new examples or embodiments, which also belong to the protection scope of the present disclosure.

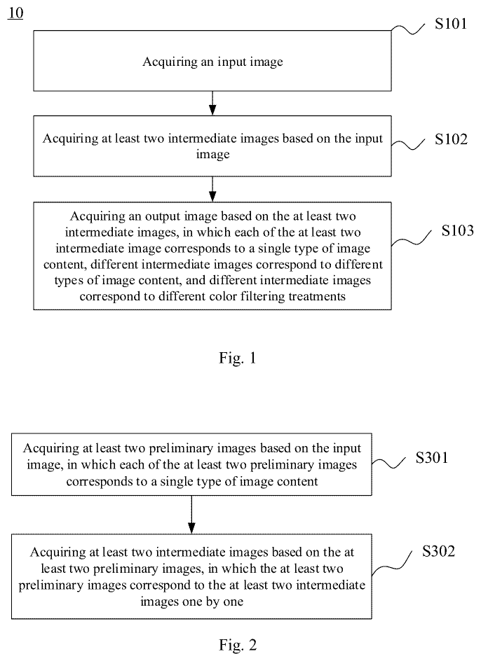

FIG. 1 is a schematic flowchart of an image processing method provided by at least one embodiment of the present disclosure.

At least one embodiment of the present disclosure provides an image processing method 10, as illustrated in FIG. 1. For example, the image processing method 10 can be applied to any scenario where image color filtering (or image color conversion) is required, e.g., it can be applied to ink screens, e-books, printers, etc., or to other aspects, which is not limited by the embodiments of the present disclosure. As illustrated in FIG. 1, the image processing method 10 may include the following steps S101 to S103.

Step S101: acquiring an input image.

Step S102: acquiring at least two intermediate images based on the input image.

Step S103: acquiring an output image based on the at least two intermediate images, in which each of the at least two intermediate image corresponds to a single type of image content, different intermediate images correspond to different types of image content, and different intermediate images correspond to different color filtering processes.

For example, in at least one embodiment of the present disclosure, for step S101, the input image may be any image to be processed. For example, the input image may be a color image or a grayscale image. For another example, the input image may be an advertisement image, a chest card image, a landscape image, and etc., which is not limited by the embodiments of the present disclosure, and can be set according to actual requirements.

For example, in at least one embodiment of the present disclosure, for step S102, acquiring at least two intermediate images based on an input image may include: generating at least two intermediate images according to types of image contents in the input image. For example, the input image includes many types of image contents, such as texts, portraits, geometric graphics (such as circles, rectangles, triangles, parallelograms, ellipses, semicircles) and so on. For example, in an example, the input image is an advertising image, which can include a text introduction of the product, a face image of the spokesperson and a geometric graphical logo at the same time. For example, the intermediate image may be an image that includes a single type of image content alone, such as a layer that includes text alone, a layer that includes portrait alone, a layer that includes geometric graphic alone, or a layer that includes background (e.g., an image background with texts, portraits, and geometric graphics removed) alone. For example, in the embodiments of the present disclosure, a most suitable or an optimal color filtering algorithm can be selected and applied to each of the intermediate images, to achieve an optimal color filtering effect. For example, in the embodiments of the present disclosure, a predetermined text color filtering algorithm is used for an intermediate image that includes text alone, a predetermined portrait color filtering algorithm is used for an intermediate image that includes portrait alone, and so on, which is not limited by the embodiments of the present disclosure.

It should be noted that, in the embodiments of the present disclosure, an “intermediate image” is limited neither to a particular certain image(s), nor to a particular order, and can be set according to actual requirements.

For example, in at least one embodiment of the present disclosure, for step S103, an output image is acquired based on the at least two intermediate images. Each of the at least two intermediate image corresponds to a single type of image content, different intermediate images correspond to different image contents, and different intermediate images correspond to different color filtering processes. For example, in at least one embodiment of the present disclosure, a final output image can be obtained by fusing (merging) the at least two intermediate images. In this way, the problem of bad color filtering effect due to use of single color filtering algorithm in complex scenario can be solved. By generating a plurality of intermediate images from the input image and applying different color filtering processes to different intermediate images, the different requirements for different image contents in the same image can be met, and the color filtering effect of the whole image can be improved.

FIG. 2 is an operational flowchart of an image processing method provided by at least one embodiment of the present disclosure.

For example, in at least one embodiment of the present disclosure, for step S102, acquiring at least two intermediate images based on the input image may include the following operations S301 and S302, as illustrated in FIG. 2.

S301: acquiring at least two preliminary images based on the input image, in which each of the at least two preliminary images corresponds to a single type of image content.

S302: acquiring at least two intermediate images based on the at least two preliminary images, in which the at least two preliminary images correspond to the at least two intermediate images one by one.

For example, in at least one embodiment of the present disclosure, a preliminary image may refer to a mask image from the input image or a layer without color filtering, in which each preliminary image corresponds to one type of image content. It should be noted that, in the embodiments of the present disclosure, a “preliminary image” is limited neither to a particular certain image(s), nor to a particular order, and can be set according to actual requirements. For example, in some examples, the mask image may be a binary image, for which, e.g., the pixel values of the target regions or the regions of interest are “255” and the pixel values of other regions are “0”. Of course, the embodiments of the present disclosure are not limited thereto. For example, in an example, a preliminary image may refer to a layer that includes a single type of image content alone and has not been processed by color filtering, which is not limited by the embodiments of the present disclosure. In this way, different intermediate images to which different color filtering processes are applied can be acquired based on the plurality of preliminary images, thereby obtaining the final output image.

For example, in at least one embodiment of the present disclosure, the at least two preliminary images include at least two of the first preliminary image, the second preliminary image, the third preliminary image and the fourth preliminary image. For example, in at least one embodiment of the present disclosure, the first preliminary image corresponds to a text type of image content, the second preliminary image corresponds to a portrait type of image content, the third preliminary image corresponds to a geometric graphic type of image content, and the fourth preliminary image corresponds to a background type of image content. In this way, different preliminary images can be generated from the input image according to the types of image contents, so as to select the optimal color filtering processing method for the different types of image contents.

It should be noted that in the embodiments of the present disclosure, none of the “first preliminary image”, the “second preliminary image”, the “third preliminary image” and the “fourth preliminary image” are limited neither to a particular certain image(s), nor to a particular order, and can be set according to actual requirements.

It should also be noted that in the embodiments of the present disclosure, the input image may include one or more image types at the same time, and it is not necessary to obtain the first preliminary image, the second preliminary image, the third preliminary image and the fourth preliminary image at the same time from a same input image, depending on the actual situation.

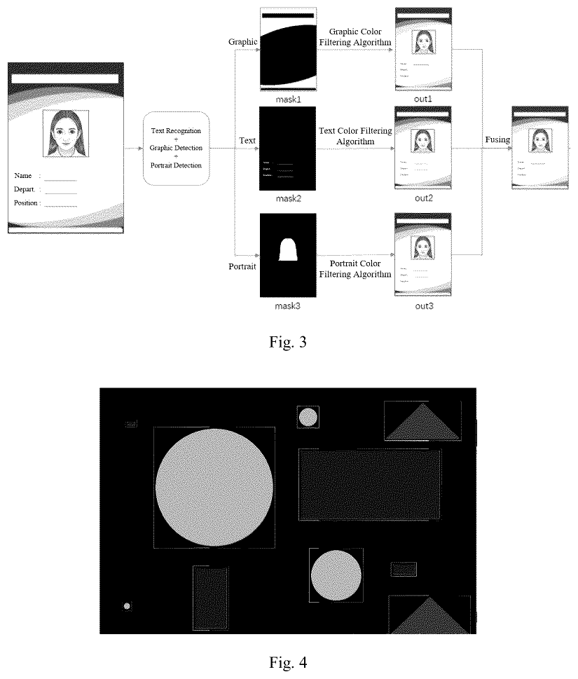

FIG. 3 is a schematic diagram of an image processing scheme provided by at least one embodiment of the present disclosure.

For example, in the example illustrated in FIG. 3, for a chest card template image, a mask image mask2 (i.e., the first preliminary image) corresponding to the text type, a mask image mask3 (i.e., the second preliminary image) corresponding to the portrait type, and a mask image mask1 (i.e., the third preliminary image) corresponding to the geometric graphic type can be obtained. For example, the mask image mask2 can be regarded as a binary image for which the pixel values in the areas corresponding to texts are “255” and the pixel values in other areas are “0”, the mask image mask3 can be regarded as a binary image for which the pixel values in the areas corresponding to portraits or faces are “255” and the pixel values in other areas are “0”, and the mask image mask1 can be regarded as a binary image for which the pixel values in the areas corresponding to geometric graphics are “255” and the pixel values in other areas are “0”, which is not limited by the embodiments of the present disclosure.

For example, in at least one embodiment of the present disclosure, for step S301, the operation of acquiring at least two preliminary images based on the input image may include: performing text detection on the input image to acquire the first preliminary image; performing portrait detection on the input image to acquire the second preliminary image; and/or performing geometric graphic detection on the input image to acquire the third preliminary image. In this way, a plurality of preliminary images can be automatically recognized or divided from the input image.

For example, in at least one embodiment of the present disclosure, for an image to be processed, i.e., the input image, before the color filtering treatment, various detection algorithms are used in advance to detect and segment different types of image contents in the input image. For example, the detection algorithm may include a text recognition algorithm, a geometric graphic detection algorithm, a portrait detection algorithm, etc., which is not specifically limited by the embodiments of the present disclosure. Various known conventional detection algorithms may be adopted as long as correct detection results can be obtained therethrough.

For example, in the example illustrated in FIG. 3, the mask image mask2 (i.e., the first preliminary image), the mask image mask3 (i.e., the second preliminary image) and the mask image mask1 (i.e., the third preliminary image) are obtained using the text recognition algorithm, the geometric graphic detection algorithm and the portrait detection algorithm respectively.

FIG. 4 is a schematic diagram of a geometric graphic detection algorithm provided by at least one embodiment of the present disclosure.

For example, in at least one embodiment of the present disclosure, as illustrated in FIG. 4, the geometric graphic detection algorithm can detect simple geometric graphics such as triangles, circles, rectangles, parallelograms, ellipses, semicircles, etc., from the input image, calculate positions and sizes for the geometric graphics, and calculate a mask image in the input image (i.e., the third preliminary image) for each of the geometric graphics.

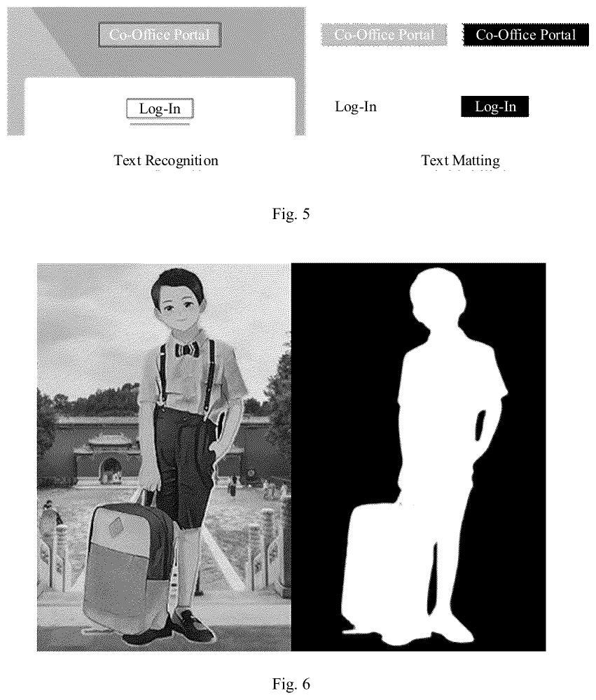

FIG. 5 is a schematic diagram of a text detection algorithm provided by at least one embodiment of the present disclosure.

For example, in at least one embodiment of the present disclosure, as illustrated in FIG. 5, the text detection algorithm includes two steps: a text recognition algorithm and a text matting algorithm. The text recognition algorithm is used to detect whether the input image contains a text or not, and frame out the text part (text area) in the input image. The text matting algorithm is used to pick out the text from the framed-out content, so as to obtain a mask of text, i.e., the first preliminary image.

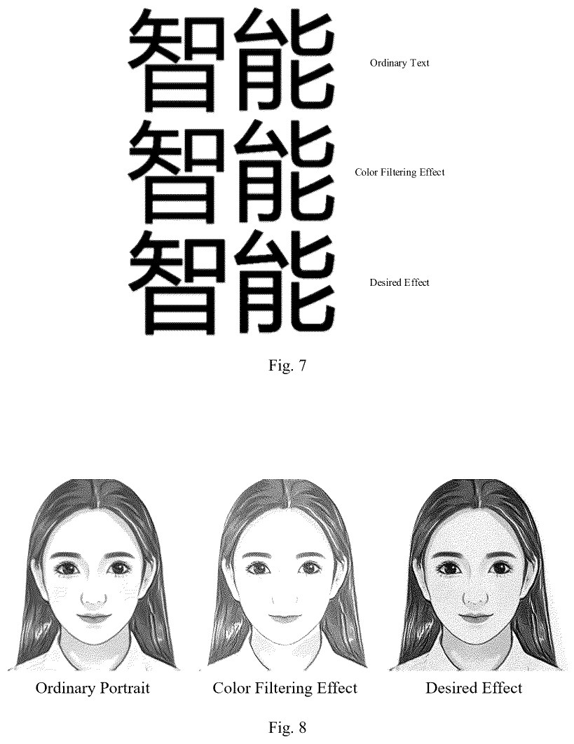

FIG. 6 is a schematic diagram of a portrait detection algorithm provided by at least one embodiment of the present disclosure.

For example, in at least one embodiment of the present disclosure, as illustrated in FIG. 6, the portrait detection algorithm includes two steps: a face recognition algorithm and a portrait matting algorithm. The face recognition is used to detect whether the input image contains a portrait, such as an ID photo. The portrait matting algorithm is used to pick out the portrait detected by the face recognition algorithm, so as to obtain a mask of portrait, i.e., the second preliminary image.

For example, in at least one embodiment of the present disclosure, for step S301, the operation of acquiring at least two preliminary images based on the input image may include: acquiring the fourth preliminary image based on the first preliminary image, the second preliminary image and the third preliminary image. For example, in at least one embodiment of the present disclosure, the fourth preliminary image corresponds to the remaining area in the input image with texts, portraits and geometric graphics removed. For example, in an embodiment, the corresponding pixel values of the above described three mask images mask1, mask2 and mask3 can be added and inverted, so as to obtain a background mask image, i.e., the fourth preliminary image. In this way, the background mask image, i.e., the fourth preliminary image, can be obtained without using other identification and detection methods.

For example, in at least one embodiment of the present disclosure, various color filtering algorithms, such as text filtering algorithm, geometric graphic filtering algorithm, portrait filtering algorithm, natural image filtering algorithm (herein also referred to as background filtering algorithm), etc., can be adopted on purpose according to different types of image content. The types of color filtering algorithms are not specifically limited by the embodiments of the present disclosure, and can be set according to actual requirements. For example, different color filtering algorithms can set different color filtering parameters, to achieve an optimal color filtering effect for the target image. It should be noted that the various parameters of different color filtering algorithms can be preset, which is not limited by the embodiments of the present disclosure.

FIG. 7 is a schematic diagram of a text color filtering algorithm provided by at least one embodiment of the present disclosure.

For example, in at least one embodiment of the present disclosure, for color filtering on ordinary texts, from the perspective of aesthetics and accuracy, the color filtering algorithm should give priority to the clarity of texts and the fluency of outlines of texts, and set and adjust the algorithm parameters based on this. For example, in an example, for the Original Text in the first row in FIG. 7, the Color Filtering Effect of the text content processed using a general color filtering algorithm is as illustrated in the second row in FIG. 7. When there are problems such as compression, blurring, etc., in the text image, phenomena such as jagging, splattering, etc., occur in the color filtering result, which is not conducive to the clear display of the text content. In this case, by adjusting the parameters of the color filtering algorithm and other means, a set of color filtering algorithms for ordinary text content is constructed, in order to obtain clearer text content, as illustrated in the Desired Effect of the third row in FIG. 7.

FIG. 8 is a schematic diagram of a portrait color filtering algorithm provided by at least one embodiment of the present disclosure.

For example, in at least one embodiment of the present disclosure, the Original Portrait, the Color Filtering Effect under the general color filtering algorithm and the Desired Effect are illustrated in FIG. 8. When color filtering is performed on a face image, the brightness of the skin color should be maintained, with the edges and contours transitioning natural and without any sense of boundary.

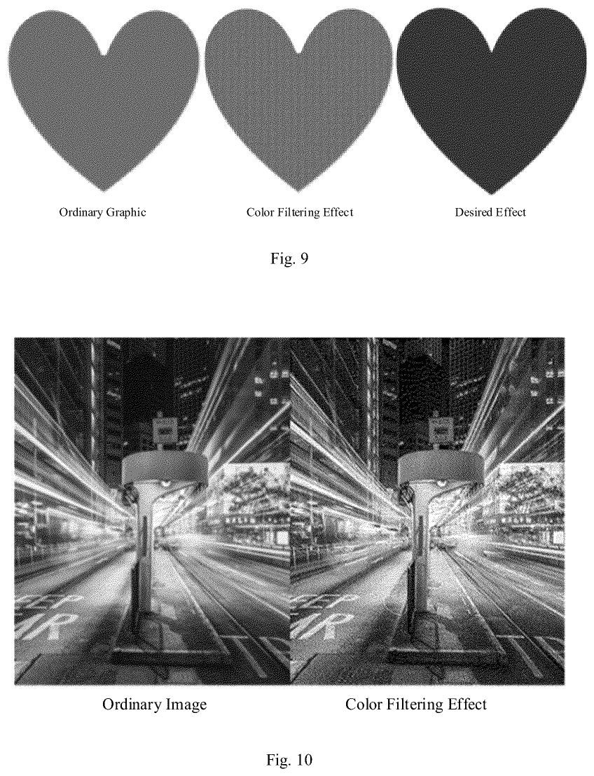

FIG. 9 is a schematic diagram of a geometric graphic color filtering algorithm provided by at least one embodiment of the present disclosure.

For example, in at least one embodiment of the present disclosure, for the geometric graphic color filtering algorithm, in the process of adjusting the color filtering parameters, it is required to avoid deformation and jagging for the edges of graphics, and meanwhile for the solid color filling inside a regular graphic, to convert it into a unified color closest to the primary color or a compact distribution of pixel points with several colors, and for thinner lines, to maintain the converted lines continuous and smooth. The Original Graphic, the Color Filtering Effect under the general color filtering algorithm and the Desired Effect are illustrated in FIG. 9.

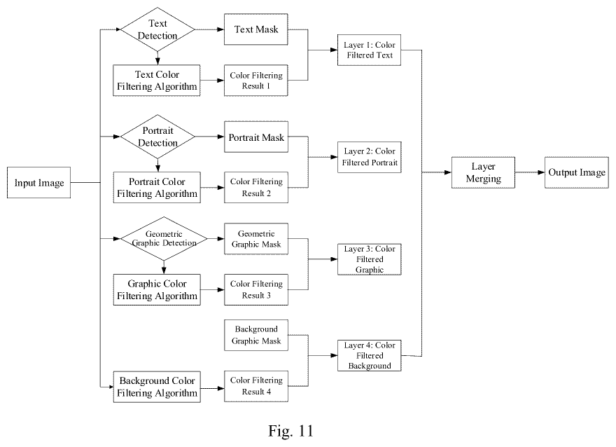

FIG. 10 is a schematic diagram of a natural image color filtering algorithm provided by at least one embodiment of the present disclosure.

For example, in at least one embodiment of the present disclosure, for a natural image or a background image, the sparsity of pixel points is used to present the intensity of saturation, presenting the gray scales and details of the original image as much as possible. The original image and the desired color filtering effect are illustrated in FIG. 10.

For example, in at least one embodiment of the present disclosure, the corresponding intermediate image is obtained by adopting the corresponding color filtering process based on the image type corresponding to a certain preliminary image. The plurality of intermediate images corresponds to the plurality of preliminary images one by one. For example, in at least one embodiment of the present disclosure, the at least two intermediate images include at least two of the first intermediate image, the second intermediate image, the third intermediate image, and the fourth intermediate image.

It should be noted that in the embodiments of the present disclosure, the “first intermediate image”, the “second intermediate image”, the “third intermediate image” and the “fourth intermediate image” are limited neither to a particular certain image(s), nor to a particular order, and can be set according to actual requirements.

It should also be noted that in the embodiments of the present disclosure, one or more types of intermediate images can be obtained based on the input image, and it is not necessary to obtain the first intermediate image, the second intermediate image, the third intermediate image and the fourth intermediate image at the same time based on a same input image, depending on the actual situation.

For example, in at least one embodiment of the present disclosure, the corresponding color filtering algorithm may be determined based on the image content's type corresponding to the preliminary image, thereby obtaining the corresponding intermediate image.

For example, in at least one embodiment of the present disclosure, for step S302, the operation of acquiring at least two intermediate images based on the at least two preliminary images may include: obtaining the first intermediate image based on the first preliminary image and the input image applied by the text color filtering processing; obtaining the second intermediate image based on the second preliminary image and the input image applied by the portrait color filtering processing; obtaining the third intermediate image based on the third preliminary image and the input image applied by the geometric graphic color filtering processing; and/or obtaining the fourth intermediate image based on the fourth preliminary image and the input image applied by the background color filtering processing. In this way, different intermediate images to which different color filtering processes are applied can be obtained, meeting the different requirements for different image contents in the same image and improving the color filtering effect for the whole image.

For example, in at least one embodiment of the present disclosure, a mask image corresponding to a text area is obtained utilizing text detection, the input image is applied by the text color filtering, and then a result of the color filtering process is superimposed according to the mask image (e.g., the input image processed by the text color filtering is multiplied with the mask image), so as to obtain the first intermediate image. In a similar way, the second intermediate image, the third intermediate image and the fourth intermediate image are obtained.

For example, in at least one embodiment of the present disclosure, for step 102, acquiring an output image based on the at least two intermediate images may include: merging the at least two intermediate images to obtain the output image. For example, in at least one embodiment of the present disclosure, the first intermediate image, the second intermediate image, the third intermediate image and the fourth intermediate image are merged to obtain a final complete image, i.e., the output image. In this way, different intermediate images to which different color filtering processes are applied are merged to obtain the output image, solving the problem of bad color filtering effect due to use of single color filtering algorithm in complex scenario.

For example, in at least one embodiment of the present disclosure, merging the first intermediate image, the second intermediate image, the third intermediate image and the fourth intermediate image to obtain the output image may include: adding, in response to there being no overlapping part among the first intermediate image, the second intermediate image, the third intermediate image and the fourth intermediate image, respective pixel values in the first intermediate image, the second intermediate image, the third intermediate image and the fourth intermediate image to obtain the output image. In this way, in the case that the plurality of intermediate images do not overlap with each other, the output image can be obtained by means of simple addition.

For example, in at least one embodiment of the present disclosure, merging the first intermediate image, the second intermediate image, the third intermediate image, and the fourth intermediate image to obtain the output image may include: basing, in response to there being an overlapping part among the first intermediate image, the second intermediate image, the third intermediate image and the fourth intermediate image, pixel values of the overlapping part on the intermediate image with the highest priority of at least two intermediate images including the overlapping part. In this way, when there is overlap among the plurality of intermediate images, the output image can be calculated by the priority settings of the intermediate images.

FIG. 11 is a schematic block diagram of an image processing method provided by at least one embodiment of the present disclosure.

For example, in at least one embodiment of the present disclosure, as illustrated in FIG. 11, for the input image, it may be a picture selected by the user, e.g., a picture in a format of jpg, png, bmp, etc. Firstly, a geometric graphic mask, a text mask and a portrait mask in the input image are calculated by means of algorithm such as the geometric graphic detection, the text detection and the portrait detection. The original input image is applied by the geometric graphic color filtering, the text color filtering, the portrait color filtering and the background color filtering, respectively. Then, respectively, the text color filtering result (i.e., color filtering result 1) is superimposed with the corresponding text mask, the portrait color filtering result (i.e., color filtering result 2) is superimposed with the corresponding portrait mask, the geometric graphic color filtering result (i.e., color filtering result 3) is superimposed with the corresponding geometric graphic mask, and the background color filtering result (i.e., color filtering result 4) is superimposed with the corresponding background mask, so that a total of 4 layer, a color filtered text (layer 1), a color filtered portrait (layer 2), a color filtered graphic (layer 3) and a color filtered background (layer 4), are obtained, respectively. At last, the four layers are merged to obtain a complete color filtering image, i.e., the output image.

It should be noted that the specific implementation of each of the block diagrams illustrated in FIG. 11 can refer to the related description of the image processing method 10, which will not be detailed here.

For example, in at least one embodiment of the present disclosure, the geometric graphic detection is performed on the input image X. When a geometric graphic is detected, a mask image M1 corresponding to the geometric graphic is extracted, and an image X1 is obtained by processing the input image X utilizing the geometric graphic color filtering algorithm. The text detection is performed on the input image X. When a text is detected, a mask image M2 corresponding to the text is extracted, and an image X2 is obtained by processing the input image X utilizing the text color filtering algorithm. The portrait detection is performed on the input image X. When a portrait is detected, a mask image M3 corresponding to the portrait is extracted, and an image X3 is obtained by processing the input image X utilizing the portrait color filtering algorithm. An image X4 is obtained by processing the input image X utilizing the background color filtering algorithm. Then, a mask image M4 corresponding to the background is obtained by adding and inverting the mask image M1, the mask image M2 and the mask image M3 that are extracted in the above steps. For example, the final merged output image Y can be expressed as

$$Y = X 1 \times M 1 + X 2 \times M 2 + X 3 \times M 3 + X 4 \times M 4.$$

For example, in at least one embodiment of the present disclosure, in the case that the first intermediate image, the second intermediate image, the third intermediate image and the fourth intermediate image do not overlap with each other, the merging process may be to add the respective pixel values of the four intermediate images. In the case that an overlapping area among the first intermediate image, the second intermediate image, the third intermediate image and the fourth intermediate image exists, the pixel values in the overlapping area are determined based on the priorities of the intermediate images including the overlapping area.

For example, in the embodiments of the present disclosure, the priority order of the first intermediate image, the second intermediate image, the third intermediate image and the fourth intermediate image may be set as the first intermediate image>the second intermediate image>the third intermediate image>the fourth intermediate image. For example, when merging the plurality of intermediate images, when there is an overlapping area among the different intermediate images, the pixel values of the overlapping area are determined according to an intermediate image with a higher priority. For example, in an example, for an overlapping area A, an intermediate image (the first intermediate image) corresponding to a text covers the overlapping area A, and an intermediate image (the third intermediate image) corresponding to a geometric graphic also covers the overlapping area A, therefore, when merging the plurality of intermediate images, the pixel values taken for the overlapping area A depends on the pixel values of the corresponding overlapping area A of the first intermediate image with the higher priority, not the pixel values of the corresponding overlapping area A of the third intermediate image.

It should be noted that the priority order of the at least two intermediate images can be set according to actual requirements, which is not limited by the embodiments of the present disclosure.

For example, in at least one embodiment of the present disclosure, for step S301, acquiring at least two preliminary images based on the input image may include: taking, in response to the input image being an editable vector graph with at least two layers, the at least two layers respectively as the at least two preliminary images, in which each of the at least two layers corresponds to a single type of image content. In the case that the input image is an editable vector graph with at least two layers, the plurality of preliminary images can be directly obtained by parsing without performing operations such as text detection, portrait detection or geometric graphic detection.

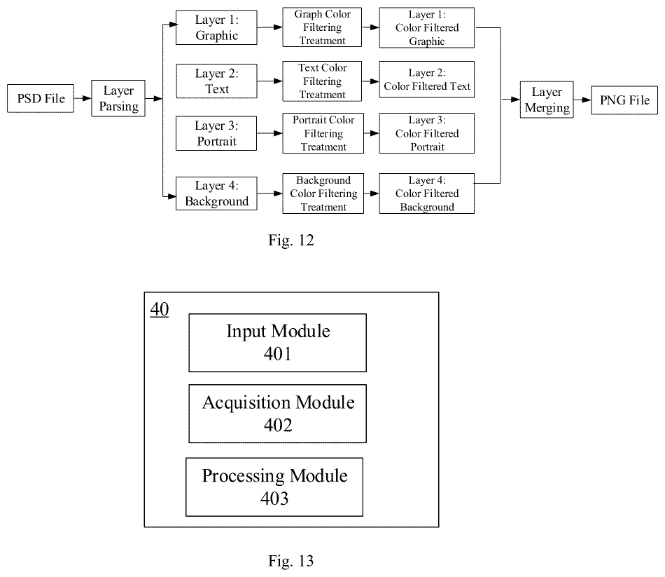

FIG. 12 is a schematic block diagram of another image processing method provided by at least one embodiment of the present disclosure.

For example, in at least one embodiment of the present disclosure, for a professional scenario, the input image may be a template image designed by a designer user. For example, an editable vector graph PSD file output by a professional software (such as Photoshop etc.) can be directly used as the input for image processing, as illustrated in FIG. 12. When designing the manuscript, the designer user can mark related types on each layer, such as geometric graphic, text, portrait, background image, etc. At least two different types of layers, i.e., preliminary images, can be obtained by reading a PSD file and parsing label names for each layer.

For example, in at least one embodiment of the present disclosure, for step S302, acquiring at least two intermediate images based on the at least two preliminary images may include: performing a corresponding color filtering process on each of the at least two preliminary images to obtain the at least two intermediate images. For example, in at least one embodiment of the present disclosure, as illustrated in FIG. 12, different color filtering processes (e.g., geometric graphic color filtering treatment, text color filtering treatment, portrait color filtering treatment, etc.) are performed on each layer obtained by parsing, thereby obtaining corresponding intermediate images, i.e., the color filtered layers. In the case that the input image is an editable vector graph with at least two layers, the corresponding intermediate images can be obtained by directly performing the corresponding color filtering processes on the respective preliminary images.

For example, in at least one embodiment of the present disclosure, the color filtered layers (i.e., intermediate images) are merged to obtain a final PNG picture. The layer merging operation can refer to the related description of step 103 in the image processing method 10, which will not be detailed here.

The image processing method 10 provided by at least one embodiment of the present disclosure, by adopting different color filtering processes for at least two different types of intermediate images of an input image, can meet different requirements for different types of image contents in a same image, and improve color filtering effect for the whole image, thereby solving the problem of bad color filtering effect due to use of single color filtering algorithm in complex scenario.

It should also be noted that in various embodiments of the present disclosure, the execution order of the respective steps in the image processing method 10 is not limited. While the execution process of the respective steps is described in a particular order in the above, this does not constitute a limitation to the embodiments of the present disclosure. The respective steps in the image processing method 10 can be performed in series or in parallel, which can be determined according to actual requirements. For example, the image processing method 10 may also include more or fewer steps, which is not limited by the embodiments of the present disclosure.

At least one embodiment of the present disclosure also provides an image processing device, which, by adopting different color filtering processes for at least two different types of intermediate images of an input image, can meet different requirements for different types of image contents in a same image, and improve color filtering effect for the whole image, thereby solving the problem of bad color filtering effect due to use of single color filtering algorithm in complex scenario.

FIG. 13 is a schematic block diagram of an image processing device provided by at least one embodiment of the present disclosure.

For example, in at least one embodiment of the present disclosure, as illustrated in FIG. 13, an image processing device 40 includes an input module 401, an acquisition module 402, and a processing module 403.

For example, in at least one embodiment of the present disclosure, the input module 401 is configured to acquire an input image. For example, the input module 401 can implement step S101, the specific implementation of which can refer to the related description of step S101, which will not be detailed here.

For example, in at least one embodiment of the present disclosure, the acquisition module 402 is configured to acquire at least two intermediate images based on the input image. For example, the acquisition module 402 can implement step S102, the specific implementation of which can refer to the related description of step S102, which will not be detailed here.

For example, in at least one embodiment of the present disclosure, the processing module 403 is configured to acquire an output image based on the at least two intermediate images, in which each of the at least two intermediate image corresponds to a single type of image content, different intermediate images correspond to different types of image content, and different intermediate images correspond to different color filtering processes. For example, the processing module 403 can implement step S103, the specific implementation of which can refer to the related description of step S103, which will not be detailed here.

It should be noted that the input module 401, the acquisition module 402 and the processing module 403 can be implemented by software, hardware, firmware or any combination thereof, for example, can be implemented respectively as an input circuit 401, an acquisition circuit 402 and a processing circuit 403, the specific implementations of which are not limited by the embodiments of the present disclosure.

It should be understood that the image processing device 40 provided by the embodiments of the present disclosure can implement the aforementioned image processing method 10, and can also achieve the technical effects similar to those of the aforementioned image processing method 10, which will not be detailed here.

It should be noted that in the embodiments of the present disclosure, the image processing device 40 may include more or less circuits or units, and the connection relationships between the respective circuits or units are not limited and may be determined according to actual requirements. The respective circuits are not limited in terms of specific composition, and can be composed of analog devices, or digital chips, or other suitable ways, according to principle of circuit.

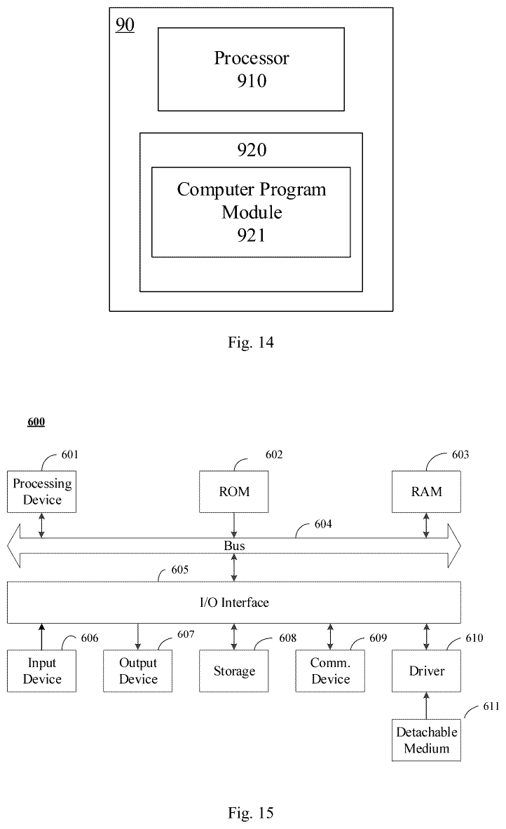

FIG. 14 is a schematic block diagram of another image processing device provided by at least one embodiment of that present disclosure.

At least one embodiment of the present disclosure also provides an image processing device 90. As illustrated in FIG. 14, the image processing device 90 includes a processor 910 and a memory 920. The memory 920 includes one or more computer program modules 921. The one or more computer program modules 921 are stored in the memory 920 and configured to be executed by the processor 910. The one or more computer program modules 921 include instructions for performing the image processing method 10 provided by at least one embodiment of the present disclosure. The instructions, when executed by the processor 910, can perform one or more steps of the image processing method 10 provided by at least one embodiment of the present disclosure. The memory 920 and the processor 910 may be interconnected by a bus system and/or another form of connection mechanism (not shown).

For example, the processor 910 may be a central processing unit (CPU), a digital signal processor (DSP) or another form of processing unit with data processing capability and/or program executing capability, such as a field programmable gate array (FPGA). For example, the central processing unit (CPU) may be of an X86 or ARM architecture. The processor 910 may be a general-purpose processor or a special-purpose processor, and may control other components in the image processing device 90 to perform desired functions.

For example, the memory 920 may include any combination of one or more computer program products including various forms of computer-readable storage media, such as volatile memory and/or non-volatile memory. The volatile memory may include, for example, random access memory (RAM) and/or cache, etc. The non-volatile memory may include, for example, read-only memory (ROM), hard disk, erasable programmable read-only memory (EPROM), portable compact disk read-only memory (CD-ROM), USB memory, flash memory, etc. The one or more computer program modules 921 may be stored on a computer-readable storage medium, and the processor 910 may run the one or more computer program modules 921 to implement various functions of the image processing device 90. Various application programs and various data, as well as various data used and/or produced by the application programs, etc., may also be stored on the computer-readable storage medium. The specific functions and technical effects of the image processing device 90 can refer to the description of the image processing method 10 in the above, which will not be detailed here.

FIG. 15 is a schematic block diagram of another image processing device 600 provided by at least one embodiment of the present disclosure.

The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), and fixed terminals such as a digital TV, a desktop computer, or the like. The image processing device 600 illustrated in FIG. 15 is merely an example, and should not pose any limitation to the functions and the range of use of the embodiments of the present disclosure.

As illustrated in FIG. 15, the image processing device 600 includes a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the computer system. The processing apparatus 601, the ROM 602, and the RAM 603 are interconnected by means of a bus 604. An input/output (I/O) interface 605 is also connected to the bus 604.

For example, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the image processing device 600 to be in wireless or wired communication with other devices to exchange data. While FIG. 15 illustrates the image processing device 600 having various apparatuses, it should be understood that not all of the illustrated apparatuses are necessarily implemented or included. More or fewer apparatuses may be implemented or included alternatively.

For example, the image processing device 600 may further include a peripheral interface (not shown in the figures) and the like. The peripheral interface can be various types of interfaces, such as a USB interface, a lighting interface, etc. The communication apparatus 609 can communicate with a network and other devices through wireless communication, such as the Internet, an intranet and/or a wireless network such as a cellular telephone network, a wireless local area network (LAN) and/or a metropolitan area network (MAN). Wireless communication can use any of a variety of communication standards, protocols and technologies, Include, but are not limited to, Global System for Mobile Communications (GSM), Enhanced Data GSM Environment (EDGE), Wideband Code Division Multiple Access (W-CDMA), Code Division Multiple Access (CDMA), Time Division Multiple Access (TDMA), Bluetooth, Wi-Fi (for example, based on IEEE 802.11a, IEEE 802.11b, IEEE 802.11g and/or IEEE 8000) Voice over Internet Protocol (VOIP), Wi-MAX, protocols for email, instant messaging and/or short message service (SMS), or any other suitable communication protocol.

For example, the image processing device 600 can be any device such as a mobile phone, a tablet computer, a notebook computer, an e-book, a game machine, a television, a digital photo frame, a navigator, etc., and can also be any combination of data processing devices and hardware, which is not limited by the embodiment of the present disclosure.

For example, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the image processing method 10 disclosed in some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned image processing device 600, or may also exist alone without being assembled into the image processing device 600.

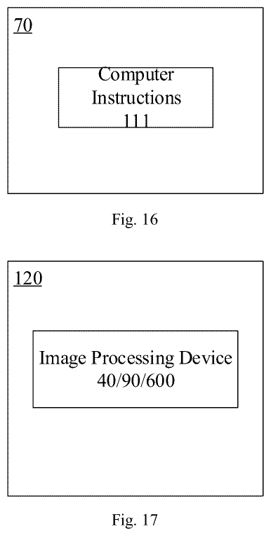

FIG. 16 is a schematic block diagram of a non-transitory readable storage medium provided by at least one embodiment of the present disclosure.

An embodiment of the present disclosure further provides a non-transitory readable storage medium. FIG. 16 is a schematic block diagram of a non-transitory readable storage medium provided by at least one embodiment of the present disclosure. As illustrated in FIG. 16, a computer instruction 111 is stored on the non-transitory readable storage medium 70; and when executed by the processor, the computer instruction 111 executes one or more steps in the image processing method 10 as described above.

For example, the non-transitory readable storage medium 70 may be any combination of one or more computer-readable storage media. For example, one computer-readable storage medium contains computer-readable program codes for acquiring an input image, another computer-readable storage medium contains computer-readable program codes for acquiring at least two intermediate images based on the input image, another computer-readable storage medium contains computer-readable program codes for acquiring an output image based on the at least two intermediate images, in which each of the at least two intermediate image corresponds to a single type of image content, different intermediate images correspond to different types of image content, and different intermediate images correspond to different color filtering processes. Of course, the above-described respective program codes may also be stored in a same computer-readable medium, which will not be limited in the embodiments of the present disclosure.

For example, when the program codes are read by a computer, the computer may execute the program codes stored in the computer storage medium, for example, execute the image processing method 10 provided by any one embodiment of the present disclosure.

For example, the storage medium may include a memory card of a smart phone, a storage component of a tablet personal computer, a hard disk of a personal computer, a Random Access Memory (RAM), a Read-Only Memory (ROM), an Erasable Programmable Read-Only Memory (EPROM), a portable Compact Disc Read-Only Memory (CD-ROM), a flash memory, or any combination of the above-described storage media, or other applicable storage media. For example, the readable storage medium may also be the memory 920 in FIG. 14, the foregoing content may be referred to for the related description, and no details will be repeated here.

An embodiment of the present disclosure further provides an electronic device. FIG. 17 is a schematic block diagram of an electronic device according to at least one embodiment of the present disclosure. As illustrated in FIG. 17, the electronic device 120 may include the image processing device 40/90/600 as described above. For example, the electronic device 120 may implement the image processing method 10 provided by any one embodiment of the present disclosure.

In the present disclosure, the term “a plurality of” refers to two or more, unless otherwise expressly defined.

Those skilled in the art will easily think of other implementation solutions of the present disclosure after considering the specification and practicing the disclosure disclosed herein. The present disclosure is intended to cover any variant, usage or adaptive change of the present disclosure; these variants, usages or adaptive changes follow the general principles of the present disclosure and include the common knowledge or commonly used technical means in the technical field not disclosed in the present disclosure. The specification and the embodiments are only regarded as exemplary; and a true scope and spirit of the present disclosure are indicated by the following claims.

It should be understood that the present disclosure is not limited to the precise structure as described above and illustrated in the accompanying drawings, and various modifications and changes may be made without departing from the scope thereof. The scope of the present disclosure is limited only by the appended claims.

1. An image processing method, comprising:
acquiring an input image;
acquiring at least two intermediate images based on the input image; and
acquiring an output image based on the at least two intermediate images;
wherein each of the at least two intermediate image corresponds to a single type of image content, different intermediate images correspond to different types of image content, and different intermediate images correspond to different color filtering processes.

2. The method according to claim 1, wherein acquiring the at least two intermediate images based on the input image comprises:
acquiring at least two preliminary images base on that input image, wherein each of the at least two preliminary images corresponds to a single type of image content; and
acquiring the at least two intermediate images based on the at least two preliminary images, wherein the at least two preliminary images correspond to the at least two intermediate images one by one.

3. The method according to claim 2, wherein the at least two preliminary images comprise at least two of a first preliminary image, a second preliminary image, a third preliminary image, and a fourth preliminary image;
the first preliminary image corresponds to a text type of image content, the second preliminary image corresponds to a portrait type of image content, the third preliminary image corresponds to a geometric graphic type of image content, and the fourth preliminary image corresponds to a background type of image content.

4. The method according to claim 3, wherein acquiring the at least two preliminary images based on the input image comprises:
performing text detection on the input image to acquire the first preliminary image;
performing portrait detection on the input image to acquire the second preliminary image; and/or
performing geometric graphic detection on the input image to acquire the third preliminary image.

5. The method according to claim 3, wherein acquiring the at least two preliminary images based on the input image comprises:
acquiring the fourth preliminary image based on the first preliminary image, the second preliminary image, and the third preliminary image.

6. The method according to claim 3, wherein acquiring the at least two intermediate images based on the at least two preliminary images comprises:
acquiring a first intermediate image based on the first preliminary image and the input image applied by text color filtering processing;
acquiring a second intermediate image based on the second preliminary image and the input image applied by portrait color filtering processing;
acquiring a third intermediate image based on the third preliminary image and the input image applied by geometric graphic color filtering processing; and/or
acquiring a fourth intermediate image based on the fourth preliminary image and the input image applied by background color filtering processing.

7. The method according to claim 6, wherein acquiring the output image based on the at least two intermediate images comprises:
merging the first intermediate image, the second intermediate image, the third intermediate image, and the fourth intermediate image to obtain the output image.

8. The method according to claim 7, wherein merging the first intermediate image, the second intermediate image, the third intermediate image, and the fourth intermediate image to obtain the output image comprises:
adding, in response to no overlapping part among the first intermediate image, the second intermediate image, the third intermediate image, and the fourth intermediate image existing, respective pixel values in the first intermediate image, the second intermediate image, the third intermediate image, and the fourth intermediate image to obtain the output image.

9. The method according to claim 7, wherein merging the first intermediate image, the second intermediate image, the third intermediate image, and the fourth intermediate image to obtain the output image comprises:
determining, in response to an overlapping part among the first intermediate image, the second intermediate image, the third intermediate image, and the fourth intermediate image existing, pixel values of the overlapping part based on an intermediate image with the highest priority of at least two intermediate images including the overlapping part.

10. The method according to claim 6, wherein a priority order of the first intermediate image, the second intermediate image, the third intermediate image, and the fourth intermediate image is the first intermediate image>the second intermediate image>the third intermediate image>the fourth intermediate image.

11. The method according to claim 2, wherein acquiring at least two preliminary images based on the input image comprises:
taking, in response to the input image being an editable vector graph having at least two layers, the at least two layers respectively as the at least two preliminary images, wherein each of the at least two layers corresponds to a single type of image content.

12. The method according to claim 11, wherein acquiring the at least two intermediate images based on the at least two preliminary images comprises:
performing a corresponding color filtering process on each of the at least two preliminary images to obtain the at least two intermediate images.

13. The method according to claim 2, wherein each of the at least two preliminary images is a binary image.

14. The method according to claim 1, wherein the different color filtering processes comprise at least using different color filtering parameters.

15. An image processing device, comprising:
an input module, configured to acquire an input image;
an acquisition module, configured to acquire at least two intermediate images based on the input image;
a processing module, configured to acquire an output image based on the at least two intermediate images;
wherein each of the at least two intermediate image corresponds to a single type of image content, different intermediate images correspond to different types of image content, and different intermediate images correspond to different color filtering processes.

16. An image processing device, comprising:
a processor;
a memory, comprising one or more computer program modules;
wherein the one or more computer program modules are stored in the memory and configured to be executed by the processor, and the one or more computer program modules include instructions for performing the image processing method according to claim 1.

17. A non-transitory readable storage medium having computer instructions stored thereon, wherein the computer instructions, when executed by a processor, perform the image processing method according to claim 1.

18. The image processing device according to claim 15, wherein the acquisition module is further configured to:
acquire at least two preliminary images base on that input image, wherein each of the at least two preliminary images corresponds to a single type of image content; and
acquire the at least two intermediate images based on the at least two preliminary images, wherein the at least two preliminary images correspond to the at least two intermediate images one by one.

19. The image processing device according to claim 18, wherein the at least two preliminary images comprise at least two of a first preliminary image, a second preliminary image, a third preliminary image, and a fourth preliminary image; and
the first preliminary image corresponds to a text type of image content, the second preliminary image corresponds to a portrait type of image content, the third preliminary image corresponds to a geometric graphic type of image content, and the fourth preliminary image corresponds to a background type of image content.

20. The image processing device according to claim 19, wherein the acquisition module is further configured to:
perform text detection on the input image to acquire the first preliminary image;
perform portrait detection on the input image to acquire the second preliminary image; and/or
perform geometric graphic detection on the input image to acquire the third preliminary image.
